(19) United States
(12) Patent Application Publication
(10) Pub. No.: US 2024/0411157 A1
(43) Pub. Date: Dec. 12, 2024

(54) INVERSE DESIGNED PHOTONIC INTEGRATED CIRCUIT WITH IMPROVED SIGNAL TO NOISE RATIO

(71) Applicant: X Development LLC, Mountain View, CA (US)

(72) Inventor: Brian Adolf, San Mateo, CA (US)

(21) Appl. No.: 18/208,724

(22) Filed: Jun. 12, 2023

(51) Int. Cl. G02F 1/025

(52) U.S. Cl. CPC G02F 1/025

(57) ABSTRACT

A photonic integrated circuit including an optical modulator, one or more waveguides, and an outcoupler is described. The optical modulator includes a modulation region and a modulation actuator. The modulation region includes an inhomogeneous arrangement of two or more different materials having different refractive indexes to structure the modulation region to manipulate one or more optical properties of an optical carrier wave in response to a modulation bias. The modulation actuator is disposed proximate to the modulation region and adapted to apply the modulation bias to the modulation region to generate a first signal and a second signal. The outcoupler is optically coupled to the one or more waveguides to receive the first signal and the second signal and further adapted to preserve the first signal and the second signal as a combined signal directed out of the photonic integrated circuit.

### TECHNICAL FIELD

This disclosure relates generally to photonic devices, and in particular, relates to inverse designed photonic integrated circuits.

### BACKGROUND INFORMATION

Photonic integrated circuits (PIC) are integrated optical circuits containing two or more photonic components capable of detecting, generating, transporting, and/or processing light. PICs may be formed within a monolithic substrate using a variety of material systems such as silicon, lithium niobate, silica on silicon, silicon on insulator, GaAs, InP, polymers, or others. One advantage of PICs is that light (e.g., photons) can be utilized to convey information or drive functionality, which travel at a rate faster than that of electrons utilized in traditional integrated circuits. However, it is appreciated that PICs are not limited to only photonic components and that PICs may work in conjunction with electrical components.

An optical modulator is one type of photonic component that may be included in a PIC, which is an active component that allows a user to modulate an optical signal via an applied bias. This bias is typically achieved by changing a voltage which electro-optically, thermo-optically, or mechano-optically tunes the refractive index of a material in some region of an integrated device. When the bias is modulated at high speed (e.g., gigahertz rates), information and data can be encoded and transmitted to a distant receiver.

Typical photonic components are designed by humans using well understood elements (e.g., combinations of waveguide-based phase shifters and directional couplers or modulated ring resonators in the case of optical modulators). However, these conventional components have limits: they are large in footprint and have a limited number of “knobs” by which their performance can be improved and tweaked.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A illustrates an inverse designed photonic system with improved signal to noise ratio, in accordance with an embodiment of the disclosure.

FIG. 1B illustrates a top-view of a portion of the photonic system of FIG. 1A showing a first signal and a second signal traversing an individual waveguide, in accordance with an embodiment of the disclosure.

FIG. 1C illustrates an alternative embodiment of the portion of the photonic system of FIG. 1B showing the first signal and the second signal traversing different waveguides, in accordance with an embodiment of the disclosure.

FIGS. 1D-1F illustrate cross-sectional views of a portion of the photonic system of FIG. 1A, in accordance with an embodiment of the disclosure.

FIG. 2 illustrates a flow chart detailing example operation for an inverse designed photonic system with improved signal to noise ratio, in accordance with an embodiment of the disclosure.

FIG. 3 illustrates a process for inverse design of a photonic system, in accordance with an embodiment of the disclosure.

FIG. 4A illustrates a demonstrative simulated environment for simulating the operation of a physical device, in accordance with an embodiment of the disclosure.

FIG. 4B illustrates an operational simulation of a physical device, in accordance with an embodiment of the disclosure.

FIG. 4C illustrates an adjoint simulation (backpropagation) of a performance loss error through the simulated environment, in accordance with an embodiment of the disclosure.

FIG. 5A is a flow chart illustrating example time steps for operational and adjoint simulations used to inverse design the optical modulator, in accordance with an embodiment of the disclosure.

FIG. 5B is a flow chart illustrating a relationship between an operational simulation and the adjoint simulation (backpropagation), in accordance with an embodiment of the disclosure.

### DETAILED DESCRIPTION

Embodiments of a system, apparatus, method of operation, and method of design for an inverse designed photonic system with an improved signal to noise ratio are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Described herein are embodiments of an inverse designed photonic system, which includes an optical modulator that corresponds to a photonic device capable of manipulating one or more optical properties (e.g., frequency, phase, polarization, power, or combinations thereof) of an optical carrier wave (e.g., a waveform that may be modulated to convey information) by applying a modulation bias (e.g., voltage, pressure, or temperature) to the optical modulator. The inverse designed photonic system may further include one or more waveguides (e.g., slab, planar, ridge, channel), couplers (e.g., edge coupler, grating coupler) that may be designed with an inverse design methodology individually or in conjunction with the optical modulator. It is further appreciated that one or more components of the inverse designed photonic system may be distributed across two or more photonic integrated circuits (e.g., a first photonic integrated circuit optically coupled to a second photonic integrated circuit via an optical fiber). In general, inverse designed components described herein are generated by a bottom-up approach where target performance metrics are identified for one or more components of the photonic system, which then has a simulated structure iteratively optimized until an optimized structure is found that meets the target performance metrics or performance of the iteratively optimized simulated structure converges.

Inverse design of photonic components (e.g., optical modulators) are different than conventionally designed photonic components since the conventional design approach is limited in terms of parameters that can be optimized. For example, a conventional optical modulator may correspond to an optical waveguide formed from lithium niobate, which has limited parameters through which the waveguide may be tuned or designed. Consequently, an approach to designing a photonic system with a greater number of parameters able to be tuned is necessary to design a high performance and compact system capable of compensating for bottlenecks of conventional photonic devices. For example, one significant performance bottleneck of a conventional optical modulator is related to a first order inefficiency loss of approximately 50% energy that may be lost due to heating, out of plane radiation, or back reflection. Specifically, in traditional photonic modulators, the “off” state laser power may be reflected back to the laser, scattered into the far field (e.g., as out of plane radiation which may heat the optical modulator), or trapped in an undesired guided mode (e.g., which may cause crosstalk interference). In other words, if the optical modulator is an amplitude modulator with logic “OFF” and “ON” states, then most of the energy from at least one of those states may be lost or otherwise unutilized in a conventional optical modulator.

Embodiments of the disclosure include an inverse designed photonic system with improved signal to noise ratio by utilizing energy from all logic states of an optical modulator. Thus, instead of throwing away energy from one of the logic states by intentionally diverting the energy away (e.g., via heating, back reflection, scattering, or otherwise) from an output waveguide coupled to the optical modulator, first and second signals associated with a first and second logic state (e.g., OFF, ON, or one or more intermediary logic states) are generated that can be represented as a combined signal having orthogonal modes. In other words, an output of the modulator or the associated photonic integrated circuit may include alternate eigenmodes (e.g., polarization) of a traversal medium (e.g., waveguide, optical fiber, or the like) such that the approximately 50% power or energy loss that would typically occur is retained and allows both the logic states to coexist along a common traversal medium as a combined signal without interference since the spatial modes of the first signal and the second signal are independent (e.g., orthogonal).

On the receive end the combined signal may be received with another inverse designed device or photonic integrated circuit that separates the combined signal back into the first and the second signals, which can then be readout simultaneously using different photodetectors. Outputs of the photodetectors may then be coupled to a differential amplifier to generate a differential signal that is representative of the information imparted on the optical carrier wave by the optical modulator with effectively double signal to noise ratio. The signal to noise ratio is improved because losses associated with the photonic system are essentially subtracted out when the analogs to the first and second signals are subtracted from one another via the differential amplifier.

Embodiments described herein utilize an inverse design method to generate a photonic system (e.g., including one or more photonic components such as an optical modulator, an incoupler/outcoupler, and/or one or more waveguides for one or more photonic integrated circuits) capable of compensating or otherwise designing around bottlenecks of conventional photonic components (e.g., inefficiency losses, nonlinearity in response, size, or otherwise). Specifically, one or more photonic devices with a “design region” is designed, which has an inhomogeneous arrangement of two or more different materials having different refractive indexes to structure the design region to provide the intended function by manipulating one or more optical properties of atraversing wave. To generate the design of the photonic system, an iterative inverse design approach is utilized where the structure of the design regions is repeatedly updated until optimized designs are found that result in the photonic system performance converging or otherwise meeting one or more target performance metrics. More specifically, an optimization objective (e.g., a loss function that results in an output to be minimized) that considers the target performance metric is constructed.

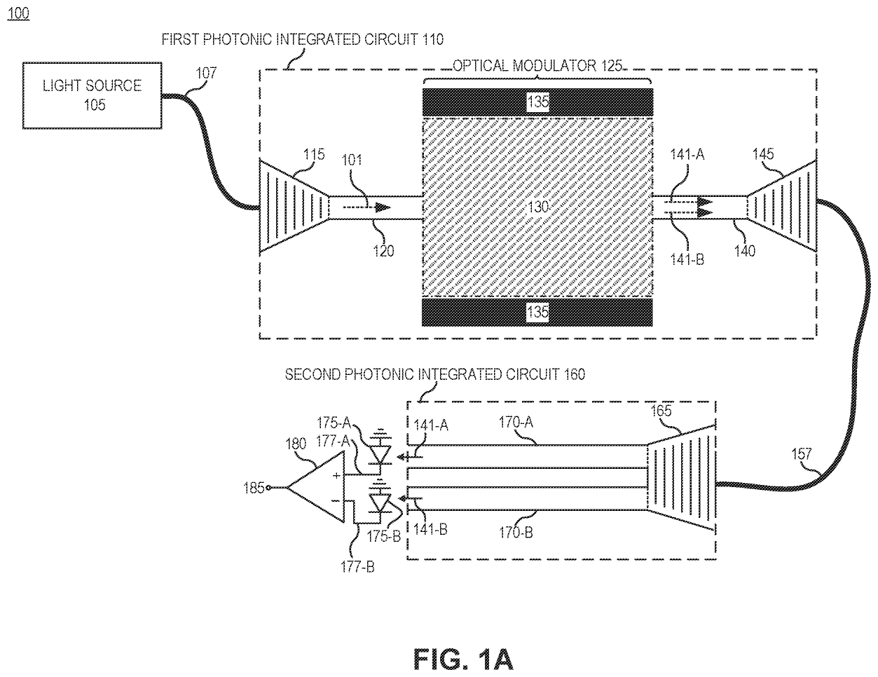

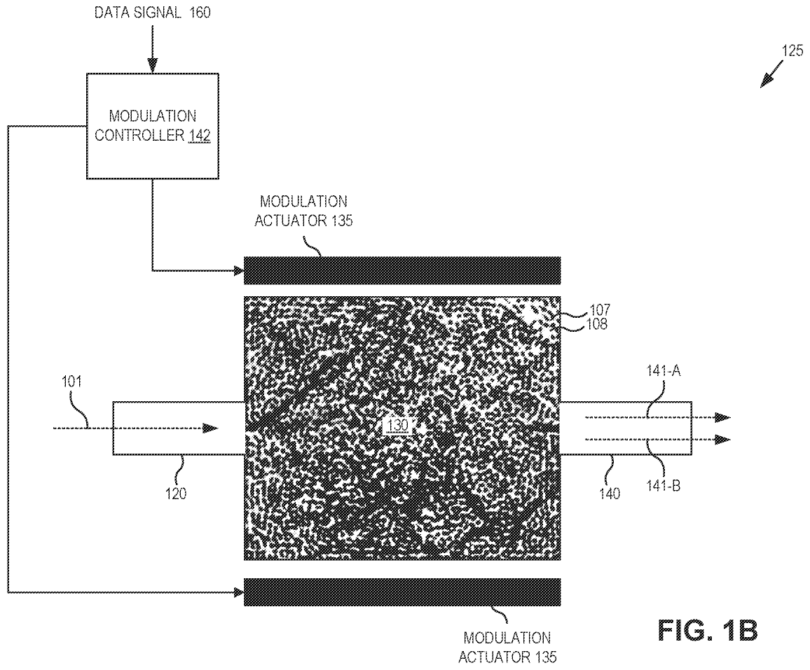

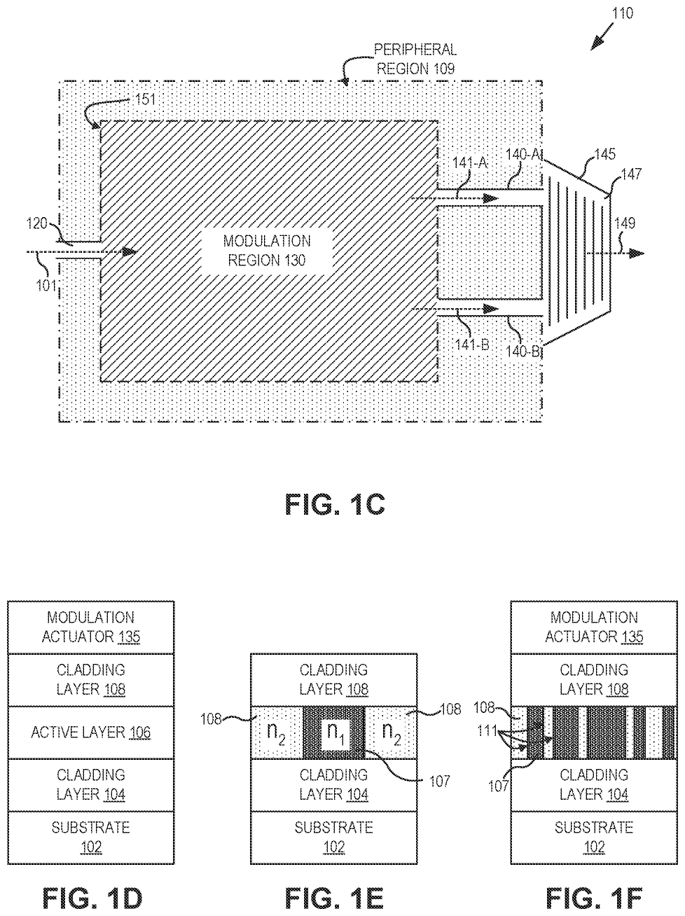

FIG. 1 illustrates an inverse designed photonic system 100 with improved signal to noise ratio, in accordance with an embodiment of the disclosure. The illustrated embodiment of the photonic system 100 includes light source 105 (e.g., a laser capable of outputting a continuous wave), optical fiber 107, first photonic integrated circuit 110, optical fiber 157, second photonic integrated circuit 160, photodetectors 175 (e.g., first photodetector 175-A and second photodetector 175-B), and differential amplifier 180. The first photonic integrated circuit 110 includes incoupler 115, input waveguide 120, optical modulator 125, output waveguide 140, and outcoupler 145. The optical modulator 125 includes modulation region 130 and modulation actuator 135. The second photonic integrated circuit 160 includes incoupler 165 and at least two waveguides 170 (e.g., an off-state waveguide 170-A and an on-state waveguide 170-B). It is appreciated that while photodetectors 175 and differential amplifier 180 are illustrated outside of the second photonic integrated circuit 160 (e.g., as part of a third monolithic integrated circuit or chip), in many embodiments said components may be incorporated into the second photonic integrated circuit 160 (e.g., as a monolithic integrated circuit or chip).

It is appreciated that couplers (e.g., incoupler 115, outcoupler 145, and incoupler 165, which may be inverse designed components that are similar to an edge coupler or grating coupler) are named based on their relative function of coupling light into or out of the first photonic integrated circuit 110 and the second photonic integrated circuit 160. However, such labels are not deemed limiting as functionality of the couplers may be bidirectional in most embodiments (e.g., instead of or in addition to the first photonic integrated circuit 110 transmitting light to the second photonic integrated circuit 160, the opposite, where the second photonic integrated circuit 160 transmits light to the first photonic integrated circuit 110, may also occur). Additionally, it is noted that in some embodiments, one or more photonic components may be omitted for the sake of clarity. For example, in some embodiments, there may be additional elements disposed between components of the first photonic integrated circuit 110 and/or the second photonic integrated circuit 160 that are not necessarily illustrated. However, in other embodiments, components may be directly coupled or otherwise abutting as illustrated (e.g., input waveguide abuts incoupler 115 and/or modulation region 130, output waveguide abuts modulation region 130 and/or outcoupler 145, or so on).

The light source 105 is adapted to generate a continuous or constant wave corresponding to an optical carrier wave 101 that has yet to have data imparted upon it. The optical carrier wave 101 is directed to the first photonic integrated circuit 110 via the optical fiber 107, which may be subsequently injected into the first photonic integrated circuit 110 via incoupler 115. In some embodiments, the incoupler 115 may condition the optical carrier wave 101 (e.g., in terms of mode, polarization, or other optical property) before being directed or otherwise injected into the input waveguide 120. The input waveguide 120 is optically coupled (directly or indirectly) to the modulation region 130 of the optical modulator 125. The modulation region 130 includes an inhomogeneous arrangement of two or more different materials (see, e.g., FIG. 1B) having different refractive indexes to structure the modulation region 130 to manipulate one or more optical properties of the optical carrier wave 101 in response to a modulation bias. The modulation actuator 135 is disposed proximate to the modulation region 130 and adapted to apply the modulation bias (e.g., adjustable voltage, current, pressure, or temperature) to the modulation region 130 to adjust at least one of the different refractive indexes of the inhomogeneous arrangement of the modulation region 130 and provide variable control of the one or more optical properties (e.g., frequency, phase, polarization, power, or combinations thereof) of the optical carrier wave 101.

In the illustrated embodiment, the modulation actuator 135 of the optical modular 125 is utilized to apply a modulation bias to the modulation region 130 to impart a data signal as a modulated signal applied over or on the optical carrier wave 101. It is appreciated that the data signal has at least two logic states (e.g., an OFF or LOW state, an ON or HIGH state, one or more intermediary states between the LOW and HIGH states, or combinations thereof) to convey information. Accordingly, the modulation actuator 135 is adapted to apply the modulation bias to the modulation region 130 to generate a first signal 141-A and a second signal 141-B, which are optical signals that may respectively be representative of the OFF and ON states of the data signal by adjusting the one or more optical properties of the optical carrier wave 101 within the modulation region 130. In other embodiments, the first signal 141-A and the second signal 141-B are representative of other states or combinations of states included in the data signal. In the same or other embodiments, the optical modulator 125 may be utilized to generate more than two optical signals depending on the number of states within the modulated signal and/or data signal. In other words, the first signal 141-A, the second signal 141-B, and/or any additional optical signals may collectively be representative of the modulated signal or data signal. Put in another way, each logic state of the data signal or modulated signal may have their own corresponding optical signal such that one or more differential signals may be generated to increase the signal to noise ratio at the receiving end of the photonic system 100.

As illustrated in FIG. 1A, the first signal 141-A and the second signal 141-B are directed towards the output waveguide 140 when the first signal 141-A and the second 141-B are alternative eigenmodes (e.g., orthogonal optical modes of the output waveguide 140 such that the first signal 141-A and the second signal 141-B may be preserved). For example, the first signal 141-A and the second signal 141-B may have different polarizations (e.g., TE-like mode and TM-like mode, respectively or vice versa). It is appreciated that due to the inverse design of the optical modulator 125 and/or incoupler 115, the eigenmode of the first signal 141-A and the second signal 141-B may not necessarily perfectly correspond to TE or TM modes of the output waveguide 141 since other higher mode orders may be utilized. Accordingly, the inhomogeneous arrangement of the modulation region 130 is structured to adjust a mode of the optical carrier wave 101 in response to the modulation bias such that the first signal 140-A traverses the output waveguide 140 (e.g., a first waveguide) with a first mode and the second signal 140-B traverses the output waveguide 140 with a second mode different from the first mode. As discussed previously, in some embodiments the first mode of the first signal 141-A is orthogonal to the second mode of the second signal 141-B. In some embodiments, the first mode or the second mode may correspond to an input mode of the optical carrier wave 101, which may be based on the output of the light source 105. In other embodiments, the incoupler 115 may be structured to configure the optical carrier wave 101 to have the input mode, which may be different from an initial mode of the optical carrier wave 101 output by the light source 105.

In other embodiments, the eigenmodes of the first signal 141-A and the second signal 141-B may be substantially similar or otherwise be not orthogonal such that if the first signal 141-A and the second signal 141-B were injected into a common waveguide information would be lost, unpreserved, or otherwise result in a substantial impact in signal to noise ratio (e.g., loss of 3 dB or more). Accordingly, in some embodiments, the modulation region 130 will direct majority portions of the optical carrier wave 101 to different waveguides depending on the modulation bias (see, e.g., FIG. 1C). Thus, the output waveguide 140 may correspond to one or more waveguides optically coupled to the modulation region 130 to receive the first signal 141-A and the second signal 141-B. In embodiments where the output waveguide 140 corresponds to two or more waveguides, the first signal 141-A and the second signal 141-B may share a common optical mode or otherwise be non-orthogonal. It is appreciated that in the illustrated embodiment, input waveguide 120 and output waveguide 140 are aligned along a common direction abutting opposite sides of the modulation region 130. In other embodiments, the input waveguide 120 and the output waveguide 140 are offset from one another. In other embodiments, the input waveguide 120 and the output waveguide 140 may abut adjacent sides or even a common side of the modulation region 130.

As illustrated in FIG. 1A, the first signal 141-A and the second signal 141-B are directed to the outcoupler 145 via the output waveguide 140. The outcoupler 145 is optically coupled (e.g., directly or otherwise) to one or more waveguides (i.e., the output waveguide 140) to receive the first signal 141-A and the second signal 141-B. It is appreciated that the outcoupler 145 is adapted to preserve the first signal 141-A and the second signal 141-B as a combined signal directed out of the first photonic integrated circuit 110 (e.g., to the optical fiber 157). Consequently, the outcoupler 145 is polarization-independent and capable of accepting different signals (e.g., the first signal 141-A, the second signal 141-B, or additional signals) with different eigenmodes. In some embodiments, the outcoupler 145 may receive different signals with a common mode or otherwise modes that are not orthogonal). In such embodiments, the outcoupler 145 is configured to adjust the eigenmode(s) of the different signals to be orthogonal (see, e.g., FIG. 1C) to generate an output signal having different modes to preserve the first signal 141-A and the second signal 141-B of the modulated signal. In the same or other embodiments, the output signal may correspond to a combined signal that is received by optical fiber 157 from the outcoupler 145 which preserves the first signal 141-A and the second signal 141-B when traversing the optical fiber 157.

The incoupler 165 of the second photonic integrated circuit 160, which is located at a different physical location than the first photonic integrated circuit 110, is adapted to receive the combined signal from the optical fiber 157 and separate the combined signal into the first signal 141-A and the second signal 141-B. More specifically, the incoupler 165 is optically coupled to at least two waveguides 170 (e.g., off-state waveguide 170-A positioned to receive the first signal 141-A and on-state waveguide 170-B positioned to receive the second signal 141-B) It is appreciated that in some embodiments, the name of the off-state waveguide 170-A and the on-state waveguide 170-B are respectively representative of different logic states of the modulated signal or data signal (e.g., the OFF or LOW state or the ON or HIGH states). However, in other embodiments, the off-state waveguide 170-A and the on-state waveguide 170-B may be representative of other logic states depending on what the first signal 141-A and the second signal 141-B represent. Additionally, if there are more than two signals included in the combined signal, then additional waveguides may be included in the at least two waveguides 170 such that the combined signal may be optically separated into its constituent signals. It is appreciated that in such embodiments, the structure of the incoupler 165 may change accordingly to facilitate polarization independence. In some embodiments, the incoupler 165 may be structured to adjust the mode of the first signal 141-A and the second signal 141-B. For example, in some embodiments, the mode or polarization of the first signal 141-A or the second signal 141-B within the incoupler 165 may be changed by the incoupler 165 when separating the first signal 141-A and the second signal 141-B from the combined signal.

As illustrated in FIG. 1A, the off-state waveguide 170-A and the on-state waveguide 170-B abut the incoupler 165 at different physical locations. In some embodiments, the off-state waveguide 170-A and the on-state waveguide 170-B are aligned parallel to one another along a common direction. Further still, the off-state waveguide 170-A and the on-state waveguide 170-B abut the incoupler 165 along a common side of the incoupler 165. However, in other embodiments, the off-state waveguide 170-A and the on-state waveguide 170-B may abut the incoupler 165 at adjacent or opposite sides of the incoupler 165. Since the off-state waveguide 170-A and the on-state waveguide 170-B interface with the incoupler 165 at different physical locations, the incoupler 165 is structured or otherwise configured to direct the first signal 141-A to the off-state waveguide 170-A and to direct the second signal 141-B to the on-state waveguide 170-B. In some embodiments, the first signal 141-A and the second signal 141-B may respectively traverse the off-state waveguide 170-A and the on-state waveguide 170-B with a mode consistent with their respective modes when traversing the output waveguide 140. However, in other embodiments the mode of the first signal 141-A and the second signal 141-B may be different when traversing the off-state waveguide 170-A and the on-state waveguide 170-B relative to the output waveguide 140. Accordingly, in some embodiments, the mode of the first signal 141-A and the second signal 141-B may not necessarily be consistent when traversing through the first photonic integrated circuit 110 and the second photonic integrated circuit 160.

The off-state waveguide 170-A and the on-state waveguide 170-B are positioned to respectively direct the first signal 141-A and the second signal 141-B to respective photodetectors 175 (e.g., photodiodes, phototransistors, or other photosensitive semiconductor components). In the illustrated embodiment, the first photodetector 175-A is optically coupled to the off-state waveguide 170-A to receive the first signal 141-A while the second photodetector 175-B is optically coupled to the on-state waveguide 170-B to receive the second signal 141-B. In some embodiments, an output of the respective photodetectors 175 may correspond to a measurable voltage or current from, or otherwise based on, the first signal 141-A and the second signal 141-B. In some embodiments, the first photodetector 175-A and the second photodetector 175-B are respectively adapted to generate a first voltage signal 177-A representative of the first signal 141-A and a second voltage signal 177-B representative of the second signal 141-B.

In the illustrated embodiment, the first photodetector 175-A and the second photodetector 175-B are coupled to the differential amplifier 180 (e.g., a transimpedance amplifier) to provide the first voltage signal 177-A and the second voltage signal 177-B to generate a differential signal 185 indicative of a difference between the first voltage signal 177-A and the second voltage signal 177-B. It is appreciated that the differential signal 185 is representative of the modulated signal (i.e., the data signal imparted on the optical carrier wave 101), which has an improved signal to noise ratio relative to conventional photonic systems. Specifically, by taking a difference between the first voltage signal 177-A and the second voltage signal 177-B, noise present in the photonic system 100 may be subtracted out from the resultant differential signal 185.

FIG. 1B illustrates a top-view of a portion of photonic system 100 of FIG. 1A showing a first signal 141-A and a second signal 141-B traversing an individual waveguide (e.g., the output waveguide 140), in accordance with an embodiment of the disclosure. More specifically, FIG. 1B illustrates a view of the optical modulator 125 included in the photonic system 100 illustrated in FIG. 1A. Referring back to FIG. 1B, the optical modulator 125 includes the modulation region 130 optically coupled to the input waveguide 120 and the output waveguide 140, the modulation actuator 135, and a modulation controller 142. The illustrated embodiment of the modulation region 130 includes an inhomogeneous arrangement of two or more different materials (e.g., first material 107 and second material 108) having different refractive indexes to structure the modulation region 130 to manipulate one or more optical properties (e.g., frequency, phase, polarization, power, or combinations thereof) of the optical carrier wave 101 in response to a modulation bias (e.g., adjustable voltage, current, pressure, or temperature) applied to the modulation region 130. It is appreciated that the inhomogeneous arrangement of the first material 107 and the second material 108 may correspond to homogeneous compositions of the first material 107 and the second material 108 (e.g., islands of the first material 107 and the second material 108) inhomogeneously interspersed within the modulation region 130. In some embodiments, the first material 107 and the second material 108 correspond to differently doped semiconductor materials (e.g., doped silicon regions such as a P-type doped semiconductor and an N-type doped semiconductor) to form a PN junction within or otherwise corresponding to the modulation region 130. In other embodiments, the modulation region 130 may include a PIN junction, which may include a P-type doped region, an intrinsic region, and an N-type doped region formed within a semiconductor material (e.g., silicon). In other words, the modulation region 130 may include a third material in some embodiments. It is appreciated that in some embodiments the first material 107 corresponds to an intrinsic (e.g., undoped) region that is inhomogeneously interspersed with a P-type doped region and/or an N-type doped region (e.g., the second material 108. It is further appreciated that optimization may further occur along a vertical direction (e.g., out of plane with the underlying substrate) in which case the second material 108 may correspond to an oxide or other insulating material inhomogeneously interspersed with a semiconductor material (e.g., at least one of a P-type doped region, an intrinsic region, and/or an N-type doped region). Collectively, materials included in the modulation region 130 are structured to cause the modulation region 130 to manipulate one or more optical properties (e.g., frequency, phase, polarization, power, or combinations thereof) of the optical carrier wave 101 in response to a modulation bias (e.g., adjustable voltage, current, pressure, or temperature) applied to the modulation region 130 by the modulation actuator 135 driven by modulation controller 142. The input waveguide 120 is optically coupled to the modulation region 130 to inject the optical carrier wave 101 into the modulation region 130. The modulation actuator 135 is disposed proximate to the modulation region 130 and adapted to apply the modulation bias to the modulation region 130 to generate the first signal 141-A and the second signal 141-B that are collectively representative of a modulated signal imparted upon the optical carrier wave 101 (e.g., to convey information representative of data signal 160). The output waveguide 140 is optically coupled to the modulation region 130 to receive the modulated signal (e.g., the first signal 141-A and the second signal 141-B).

The modulation region 130 may also be referred to as the “design region” or “active region” of the optical modulator 125, which is where the modulation bias (e.g., applied voltage, current, temperature, pressure) is capable of variably adjusting at least one of the different refractive indexes included in the inhomogeneous arrangement of the two or more different materials. For example, the two or more different materials may include the first material 107 and the second material 108, each with a respective refractive index that may change in response to the modulation bias being applied to modulation region 130. The degree of which at least one of the different refractive indexes changes is based, at least in part, on a magnitude of the modulation bias and the material properties of at least one of the two or more different materials (e.g., electro-optic coefficient of the first material 107 or the second material 108). In the illustrated embodiment, the modulation region 130 is structured as an optical cavity (e.g., a resonant cavity) and the inhomogeneous arrangement of the first material 107 and the second material 108 results in a material interface pattern that provides, in response to the modulation bias, the intended functionality for the optical modulator 125. It is appreciated that the response to the modulation bias may also include when the magnitude of the modulation bias is zero or a reference value (e.g., when the modulation bias corresponds to an applied voltage, then a magnitude of zero for the modulation bias may correspond to 0 V, ground, or a reference voltage and when the modulation bias corresponds to an applied pressure or temperature, a zero or reference value magnitude for the modulation bias may correspond to ambient pressure or temperature, and so forth).

In some embodiments, the pattern of discrete regions of the first material 107 and the second material 108 operate to selectively steer (e.g., via refraction, scattering, reflection, dispersion, or otherwise) the inbound optical carrier wave 101 received via input waveguide 120 to different waveguides included in the output waveguide 140 (see, e.g., FIG. 1C) based on modulation bias applied by the modulation actuator 130 (e.g., to implement an ON-OFF keying modulation scheme where optical power is either primarily directed to one waveguide during an ON or HIGH logic state, or primarily directed to another waveguide during an OFF or LOW logic state of the data signal 160 and/or modulated signal collectively represented by the first signal 141-A and the second signal 141-B). In other words, the modulated signal comprises a plurality of states, each represented by a corresponding signal that may traverse the output waveguide 140. In some embodiments, an ON-OFF keying modulation scheme may be implemented by modulating other aspects of the one or more optical properties of the optical carrier wave 101 (e.g., other than power or amplitude such as frequency, phase, polarization, or combinations thereof). In the same or other embodiments, the optical modulator 125 may be used to correct for distortion or otherwise provide active and/or variable manipulation of the one or more optical properties of the optical carrier wave 101 to generate a modulated signal collectively represented by a plurality of signals (e.g., the first signal 141-A and the second signal 141-B). For example, distortion in the optical carrier wave 101 may be corrected or compensated for by adjusting frequency, phase, polarization, or power of the optical carrier wave 101. It is appreciated that the ON-OFF keying modulation, distortion correction, or other schemes may be implemented by adapting the modulation actuator 125 to impart data signal 160 onto optical carrier wave 101 to generate modulated at least the first signal 141-A and the second signal 141-B via the modulation bias.

In some embodiments, first material 107 and second material 108 disposed in the modulation region 130 are discrete regions of material with different refractive indexes, at least one of which changes in response to a bias (e.g., applied voltage, current, temperature, pressure). In one embodiment, first material 107 and second material 108 may be a waveguiding core material and a waveguiding cladding material, respectively. This core and cladding material may be the same core and cladding material used to form the input waveguide 120 and the output waveguide 140. For example, first material 107 may be a semiconductor material (e.g., silicon, III-V semiconductor material, II-VI semiconductor material, lithium niobate, or other semiconductor material) while second material 108 may be an oxide material (e.g., silicon dioxide). In yet other embodiments, first material 107 and second material 108 may be implemented as discrete regions of intrinsic silicon and doped silicon, discrete regions of differently doped silicon, or may be combinations of other types of semiconductor material (e.g., III-V semiconductor material, II-VI semiconductor material, lithium niobate, combinations thereof, or the like). In one embodiment, modulation region 130 is approximately 20 μm by 20 μm while the input waveguide 120 and the output waveguide 140 have a 360 nm width and a 600 nm length. However, it is appreciated that in other embodiments different dimensions for the modulation region 130, the input waveguide 120, and the output waveguide 140 may be utilized. In some embodiments, each of the modulation region 130, the input waveguide 120, and the output waveguide 140 may be formed in or on a common substrate. The discrete regions of first material 107 and second material 108 may be implemented as conglomerations (e.g., homogeneous compositions) of each material type in incremental pixel or voxel sizes of 5 nm×5 nm. In other words, the inhomogeneous arrangement of the first material 107 and the second material 108 may be reproducible by a schematic defined by a plurality of pixels or voxels having an area of 5 nm×5 nm. Of course, other pixel or voxel resolutions may be implemented (e.g., area greater than 5 nm×5 nm or less than 5 nm×5 nm, different size pixels or voxels, uniform pixel or voxel size, non-uniform pixel or voxel size, or other configurations).

Modulation is achieved via a modulation bias that is applied to modulation region 130 via modulation actuator 135, which in turn is driven by modulation controller 142 (e.g., a microcontroller, application specific integrated circuit, field-programmable gate array, or other configurable controller coupled to or including memory) in response to data signal 160. Accordingly, modulation controller 142 may include modulation/demodulation circuitry along with driver circuitry to drive modulation actuator 135. The modulation actuator 135 may be implemented using a number of techniques to apply an adjustable electric field, temperature, or pressure to the modulation region 130. In one embodiment, modulation actuator 135 includes electrodes surrounding sides of modulation region 130 and the modulation bias is an applied voltage and/or injected current. In another embodiment, modulation actuator 135 includes one or more heating elements surrounding modulation region 130 and the modulation bias is an adjustable temperature. In yet another embodiment, modulation actuator 135 includes an electromechanical actuator (e.g., piezoelectric crystal, microelectromechanical systems, etc.) surrounding modulation region 130 and the modulation bias is an adjustable pressure. Each of these modulation biases serve to adjust at least one of the different refractive indexes of the inhomogeneous arrangement (e.g., of first material 107 and/or second material 108) to provide variable control of the one or more optical properties of the optical carrier wave 101. Specifically, the change in refractive indexes of the inhomogeneous arrangement changes how the optical carrier wave 101 interacts with at least one of the first material 107 or the second material 108 which in turn affects the scattering, refraction, reflective, and/or dispersion of optical carrier wave 101 within the modulation region 130 to form the first signal 141-A and the second signal 141-B. It is further appreciated that the modulation actuator 135 may surround the modulation region 130 in various ways. For example, if FIG. 1A includes a top-view of the modulation region 130, then an electrode of the modulation actuator 135 may lie along a common plane with the modulation region 130. In the same or other embodiments, the modulation region 130 may be sandwiched between two or more electrodes (see, e.g., FIGS. 1D-1F).

FIG. 1C illustrates an alternative embodiment of the portion of the photonic system 100 of FIG. 1B showing the first signal 141-A and the second signal 141-B traversing different waveguides (e.g., first waveguide 140-A and second waveguide 140-B included when the output waveguide 140 is represented by two or more waveguides), in accordance with an embodiment of the disclosure. As discussed previously, the output waveguide 140 may include one or more waveguides. Thus, in the illustrated embodiment, the one or more waveguides include the first waveguide 140-A to receive the first signal 141-A and the second waveguide 140-B to receive the second signal 141-B. It is appreciated that the first waveguide 140-A and the second waveguide 140-B are both optically coupled to the modulation region 130 at different physical locations such that the first waveguide 140-A is physically separated from the second waveguide 140-B. In some embodiments, the first waveguide 140-A and the second waveguide 140-B physically abut the modulation region 130 at different physical locations of the modulation region 130 (e.g., at a common side, an adjacent side, or opposite sides of the modulation region 130). Similarly, the first waveguide 140-A and the second waveguide 140-B physically abut the outcoupler 145 at different physical locations of the outcoupler 145 (e.g., at a common side, an adjacent side, or opposite sides of the outcoupler 145).

It is appreciated that the input waveguide 120 and the output waveguides 140 are each adjacent to the modulation region 130 and operate as optical inputs or outputs for propagating waves and may include longitudinal length in the direction of light propagation. In some embodiments, the input waveguide 120 and the output waveguides 140 may have a core and cladding with one end physically abutting, or otherwise optically coupled to, the modulation region 130. In various embodiments, the input waveguide 120, the modulation region 130, and the output waveguides 140, are all planar sections. These planar sections may be embedded within or on a semiconductor material such as a silicon-on-insulator (SOI) system, a photonic integrated circuit (PIC), or otherwise. In some embodiments, the core and cladding material may correspond to silicon and silicon dioxide for the input waveguide 120 and the output waveguide 140. In the same or other embodiments, the core and cladding material may correspond to first material 107 and second material 108 of the modulation region 130 (see, e.g., FIG. 1B). In yet other embodiments, the core and cladding material of the input waveguide 120 and the output waveguides 140 may be different than first material 107 and/or second material 108.

It is appreciated that the design of first photonic integrated circuit 110, including the optical modulator 125, the outcoupler 145, and components included in the first photonic integrated circuit 110 and the second photonic integrated circuit 160 illustrated in FIG. 1A is non-limiting. Rather, in some embodiments, the number of waveguides included in the output waveguide 140 may be configured based on the intended functionality of the photonic system 100. Specifically, depending on which of the one or more optical properties of the optical carrier wave 101 are to be modulated by the modulation region 105 in response to the modulation bias, the configuration of the optical modulator 125 and the output port 140 may change. For example, if the optical modulator 125 is structured to direct the first signal 141-A and the second signal 141-B to an individual waveguide as illustrated in FIG. 1A and FIG. 1B, then the output waveguide 140 may only include an individual waveguide. However, if the optical modulator is structured to direct the first signal 141-A and the second signal 141-B to different respective waveguides (e.g., first waveguide 140-A and second waveguide 140-B) as illustrated in FIG. 1C, then two or more waveguides may be optically coupled to the modulation region 130 at different physical locations.

Accordingly, in the embodiment illustrated in FIG. 1C, the modulated signal collectively represented by the first signal 141-A and the second signal 141-B may include a first state (e.g., logic state such as OFF/LOW or ON/HIGH) represented by the first signal 141-A and a second state (e.g., logic state such as ON/HIGH or OFF/LOW) represented by the second signal 141-B. Accordingly, upon application of the appropriate (or lack thereof) modulation bias applied to the modulation region 130, a first portion (e.g., a majority of optical power) of the optical carrier wave 101 is selectively steered by the inhomogeneous arrangement of the modulation region 130 to the first waveguide 140-A in response to the modulation bias when the modulated signal is modulated to the first state. Similarly, upon application of the appropriate (or lack thereof) modulation bias applied to the modulation region 130, a second portion (e.g., a majority of optical power) of the optical carrier wave is selectively steered by the inhomogeneous arrangement of the modulation region 130 to the second waveguide 140-B in response to the modulation bias when the modulated signal is modulated to the second state. It is appreciated that in some embodiments the first signal 141-A and the second signal 141-B respectively traverse the first waveguide 140-A and the second waveguide 140-B with a common mode to simultaneously represent different states of the modulated signal.

It is appreciated that the structure of the outcoupler 145 is directly related to the structure of the modulation region 130 since depending on the configuration of the optical modulator 125 within the first photonic integrated circuit 110, the functionality of the outcoupler 145 may change. In the illustrated embodiment of FIG. 1C, the outcoupler 145 is structured to receive the first signal 141-A and the second signal 141-B with the common mode at separate physical locations and generate an output signal 149 having different modes to preserve the first signal 141-A and the second signal 141-B of the modulated signal. In some embodiments, the output signal 149 may be referred to as a combined signal that is received by an optical fiber (e.g., optical fiber 157 illustrated in FIG. 1A), which represents the combination of the first signal 141-A and the second signal 141-B. It is appreciated that the different modes of the output signal 149 may not necessarily include the common mode of the first optical signal 141-A and the second optical signal 141-B (e.g., when the optical fiber to receive the output signal does not support the common mode).

Referring back to FIG. 1A, it is appreciated that the photonic system 100 may be designed together via an inverse design process that may include one or more design regions. Accordingly, each of the couplers (e.g., one or more incoupler 115, outcoupler 145, or incoupler 165), waveguides (e.g., input waveguide 120, output waveguide(s) 140, waveguides 170) may have respective design regions that may allow for adjustable structure similar to that of the modulation region 130. For example, the outcoupler 145 may include a dispersive region 147 corresponding to a design region where structure may be modified via the inverse design process. Accordingly, at least one of the modulation region 130 of the optical modulator 125 or a dispersive region (e.g., 147 illustrated in FIG. 1C) of the outcoupler (e.g., 145 or other outcouplers included in the photonic system 100) include homogeneous compositions of the first material and the second material inhomogeneously interspersed within the modulation region 130 or the dispersive region of one or more outcouplers (e.g., 147 illustrated in FIG. 1C) or incouplers. It is appreciated that the dispersive region of the incouplers or outcouplers (e.g., 115, 145, 165) of the photonic system 100 may be defined as an active region that interacts with light within a perimeter boundary of the component.

As illustrated in FIG. 1C, the modulation region 130 is a substantially planar structure with input waveguide 120, first waveguide 140-A, and second waveguide 140-B each in plane with and abutting the modulation region 130. In some embodiments, each of input waveguide 120, first waveguide 140-A, and second waveguide 140-B may abut a common or different sides of modulation region 130. In yet another embodiment, only two selected from a group including input waveguide 120, first waveguide 140-A, and second waveguide 140-B may abut a common side of modulation region 130 while the unselected waveguide included in the group may abut a side of the modulation region 130 adjacent to or opposite of the common side. As mentioned previously, it is appreciated that output waveguides 140 is not limited to an individual port or even two ports, and that in some embodiments, the output waveguides 140 may include multiple waveguides depending on the number of logical states of the modulated signal if a common mode is utilized. Additionally, it is appreciated that in the illustrated embodiment, modulation region 130 is laterally surrounded by a peripheral region 109, which may have a homogeneous composition (e.g., corresponding to one of the different materials that form modulation region 130 such as first material 107, second material 108, or any other material) which forms a material interface boundary 151 that continuously and contiguously extend laterally around modulation region 130 but for where the input waveguide 120, the first waveguide 140-A, and the second waveguide 140-B interface or otherwise abut modulation region 130. In some embodiments, the homogeneous composition of peripheral region 109 corresponds to silicon dioxide. It is appreciated that material interface boundary 151 may correspond to where there is change in refractive index due to different materials interfacing and collectively form boundaries of an optical cavity (e.g., to help mitigate optical carrier wave 101 from leaving the modulation region 130 through regions other than the input waveguide 120, the first waveguide 140-A, and the second waveguide 140-B). It is appreciated that the material interface boundaries (e.g., material interface boundary 151 and/or material interface boundaries formed by discrete regions formed by first material 107 and second material 108) define, at least in part, functionality of the optical modulator 125.

FIGS. 1D-1F illustrate cross-sectional views of a portion of the photonic system of FIG. 1A, in accordance with an embodiment of the disclosure. More specifically, FIGS. 1D-1F illustrate a vertical schematic or stack of various layers that may be included in the optical modulator 125 illustrated in FIG. 1A. Additionally, it is appreciated that the vertical schematics illustrated by FIGS. 1D-1F may similarly represent portions of other components included in the photonic system 100 illustrated in FIG. 1A (e.g., one or more of incoupler 115, input waveguide 120, output waveguide(s) 140, outcoupler 145, incoupler 165, or waveguide(s) 170 when the modulation actuator 135 is omitted). However, it is appreciated that the illustrated embodiment is not exhaustive and that certain features or elements may be omitted to avoid obscuring certain aspects of the invention. As illustrated in FIG. 1D, optical modulator 125 includes substrate 102, cladding layer 104, active layer 106, cladding layer 108, and, optionally, modulation actuator 135. In some embodiments, optical modulator 125 may be, in part or otherwise, a photonic integrated circuit or silicon photonic device (e.g., the first photonic integrated circuit 110 and/or the second photonic integrated circuit 160) that is compatible with conventional fabrication techniques (e.g., lithographic techniques such as photolithography, electron-beam lithography and the like, sputtering, thermal evaporation, physical and chemical vapor deposition, and the like).

In one embodiment a silicon on insulator (SOI) wafer may be initially provided that includes a support substrate (e.g., a silicon substrate) that corresponds to substrate 102, a silicon dioxide dielectric layer that corresponds to cladding layer 104, a silicon layer (e.g., intrinsic, doped, or otherwise), and an oxide layer (e.g., intrinsic, grown, or otherwise). In one embodiment, the silicon in active layer 106 may be etched selectively by lithography to create a pattern on the SOI wafer that is transferred to SOI wafer via a dry etch process (e.g., via a photoresist mask or other hard mask) to remove portions of the silicon. The silicon may be etched all the way down to cladding layer 104 to form voids or trenches that may subsequently be backfilled with silicon dioxide that is subsequently encapsulated with silicon dioxide to form cladding layer 108. In one embodiment, there may be several etch depths including a full etch depth of the silicon to obtain the targeted structure. In one embodiment, the silicon may be 220 nm thick and thus the full etch depth may be 220 nm. In some embodiments, this may be a two-step encapsulation process in which two silicon dioxide depositions are performed with an intermediate chemical mechanical planarization used to yield a planar surface.

FIG. 1E illustrates a more detailed view of a portion of active layer 106 (relative to FIG. 1D) taken along a portion of peripheral region 109 that includes either input waveguide 110 or one of the output waveguides 140. In the illustrated embodiment, active layer 106 includes first material 107 with a refractive index of n₁ and second material 108 with a refractive index of n₂ that is different from n₁. Homogeneous and contiguous regions of first material 107 and second material 108 may form waveguides or portions of waveguides included in the photonic system 100 illustrated in FIGS. 1A-1C. In some embodiments, cladding layers 104 and 108 may have a homogeneous composition corresponding to the second material 108 (e.g., silicon dioxide). It is noted that the illustrated embodiment of FIG. 1E, does not show modulation actuator 135 since the illustrated cross-section extends through one of input waveguide 120 or output waveguide(s) 140 as it may not be necessary to apply the modulation bias beyond the modulation region 130.

FIG. 1F illustrates a more detailed view of active layer 106 (relative to FIG. 1D) taken along modulation region 130 illustrated in FIGS. 1A-1C. As described previously, modulation region 130 includes the first material 107 (e.g., silicon) and the second material 108 (e.g., silicon dioxide), which are discrete regions of homogeneous compositions that are inhomogeneously interspersed to form a plurality of interfaces 111 that collectively form a material interface pattern. Each of the plurality of interfaces 111 that form the interface pattern correspond to a change in refractive index which the modulation region 130 to collectively structure the modulation region 130 (i.e., based on the shape and arrangement of first material 107 and second material 108) in combination with the modulation bias to provide, at least in part, the functionality of the optical modulator 125 (i.e., manipulation of one or more optical properties of an optical carrier wave 101 to generate at least a first signal 141-A and a second signal 141-B included in a modulated signal).

As illustrated, active layer 106 is disposed between cladding layer 104 and cladding layer 108, which in turn are disposed between substrate 102 and modulation actuator 135. In some embodiments, modulation actuator 135 may correspond to an electrode while substrate 102 may correspond to a counter-electrode. In some embodiments, an adjustable bias (e.g., voltage) may be applied between modulation actuator 135 and substrate 102 to generate a bias across modulation region 130. It is appreciated that in other embodiments, temperature or pressure may be applied to modulation region 130 via modulation actuator 135. Additionally, it is appreciated that in some embodiments, cladding layer 104 and/or cladding layer 108 may be omitted.

It is appreciated that in the illustrated embodiments of optical modulator 125 as shown in FIGS. 1D-1F, the change in refractive index is shown as being vertically consistent (i.e., first material 107 and second material 108 form interfaces that are substantially vertical or perpendicular to a lateral plane or cross-section of optical modulator 100. However, in the same or other embodiments, the plurality of interfaces (e.g., interfaces 111 illustrated in FIG. 1F) may not be substantially perpendicular with the lateral plane or cross-section of optical modulator 125. Additionally, it is appreciated that active regions corresponding to the modulation region of the optical modulation, the dispersive region of the coupler, and/or the dispersive region of the incoupler may include homogeneous compositions of the first material and the second material inhomogeneously interspersed within the modulation region, the dispersive region of the outcoupler, and/or the dispersive region of the incoupler. It is further appreciated that said active regions are not limited to just two materials. Indeed, additional materials may also be included in each active region (e.g., more than two doping profiles or materials may be implemented).

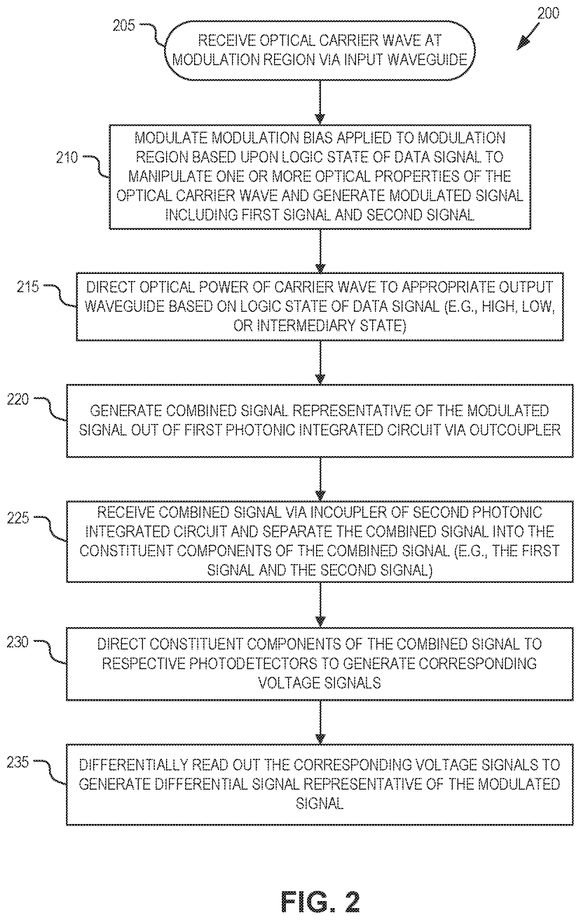

FIG. 2 is a flow chart illustrating a process 200 of operation of a photonic system, in accordance with an embodiment of the disclosure. The process 200, which includes blocks 205-235, may be one possible implementation for operating the photonic system 100 illustrated in FIG. 1A-1F. The order in which some or all of the process blocks appear in process 200 should not be deemed limiting. Rather, one of ordinary skill in the art having the benefit of the present disclosure will understand that some of the process blocks may be executed in a variety of orders not illustrated, or even in parallel.

Block 205 illustrates receiving an optical carrier wave 101 at a modulation region 130 of an optical modulator 125 via an input waveguide 120. In some embodiments, the modulation region includes an inhomogeneous arrangement of two or more different materials having different refractive indexes (e.g., first material 107 and second material 108) to structure the modulation region 130 to manipulate one or more optical properties (e.g., phase, polarization, power, frequency, or combinations thereof) of the optical carrier wave 101 in response to a modulation bias (e.g., adjustable voltage, pressure, temperature, or combinations thereof) applied to the modulation region 130. It is appreciated that the input waveguide 120 is optically coupled to the modulation region 130. Optical carrier wave 101 may be a continuous wave generated by a laser source (e.g., laser diode, etc.) guided into input waveguide 120 along a single mode waveguide (e.g., planar waveguide, fiber optic, etc.). The laser source may be an on-chip device integrated into a PIC with optical modulator 125, or a distinct off-chip device of which its output is guided to input waveguide 120 via incoupler 115.

Block 210 shows modulating the modulation bias applied to the modulation region 130 to generate a first signal 141-A and a second signal 141-B collectively representative of a modulated signal and which is directed to output waveguide(s) 140. The modulation bias adjusts at least one of the different refractive indexes of the inhomogeneous arrangement to provide variable control of the one or more optical properties of the optical carrier wave 101. Modulation actuator 135 drives the modulation bias based upon data signal 160 received at modulation controller 142. In some embodiments, modulation region 130 includes an inhomogeneous arrangement of first material 107 and second material 108 each having different refractive indexes that disperse (e.g., scatter, refract, diffract, or otherwise alter) optical carrier wave 101 in a controlled manner to manipulate one or more optical properties (e.g., power, phase, polarization, frequency, or combinations thereof) of the optical carrier wave 101 to generate the modulated signal (e.g., the first signal 140-A and the second signal 140-B).

It is appreciated that the modulation bias may be changed or otherwise adjusted to impart a data signal upon the optical carrier wave 101 to generate the modulated signal (e.g., represented, collectively, by the first signal 141-A and the second signal 141-B). The modulated signal may include a plurality of states (e.g., OFF or LOW logic state, ON or HIGH logic state, and/or one or more intermediary states), each associated with a state of the data signal 160 (e.g., 0, 1, or otherwise).

Block 215 illustrates directing optical power of the carrier wave 101 to the appropriate one of the output waveguide(s) 140 based on the logic state of the data signal (e.g., high, low, or intermediary state) with the appropriate optical mode. For example, in one embodiment, a first portion of the optical carrier wave 101 may be directed to the outcoupler 145 via a first waveguide 140-A when the modulated signal is modulated to a first state based upon a first logic state of the data signal 160. In the same or another embodiment, a second portion of the optical carrier wave 101 is directed to the outcoupler 145 via a second waveguide 140-B when the modulated signal is modulated to a second state based upon a second logic state of the data signal 160. In some embodiments, the first signal 141-A and the second signal 141-B share a common mode when received by the outcoupler 145 at different physical locations of the outcoupler 145. In other embodiments, the first signal 140-A and the second signal 140-B are directed towards a common waveguide (e.g., output waveguide 140). In such an embodiment, a first portion of the optical carrier wave 101 is directed to the outcoupler 145 via a first waveguide 140 with a first mode when the modulated signal is modulated to a first state based upon a first logic state of the data signal and a second portion of the optical carrier wave 101 is directed to the outcoupler 145 via the first waveguide 140 with a second mode, orthogonal to the first mode, when the modulated signal is modulated to a second state based upon a second logic state of the data signal. It is appreciated that a majority of the optical power may be directed to the appropriate output waveguide based on the logic state of the data signal, such that energy of the optical carrier wave 101 is not intentionally lost (e.g., each logic state of the data signal is represented by a corresponding optical signal generated by the optical modulator 125).

It is appreciated that in some embodiments the data signal may include more than two states (e.g., not just an ON and an OFF state). For example, in one embodiment, the data signal includes at least a first state, a second state, a third state, and a fourth state. In such an embodiment, a modulation scheme similar to PAM-4 (or greater), in which there are four or more distinct levels (e.g., each associated with a given logic state of the data signal) may be implemented via differential signaling. This can be achieved, in part, by imparting a data signal upon the optical carrier wave to generate the modulated signal modulating the modulation bias, which may generate at least a first signal, a second signal, a third signal, and fourth signal, each respectively representative of the first state, the second state, the third state, and the fourth state of the data signal. A first portion, a second portion, a third portion, and a fourth portion of the optical carrier wave may then be respectively directed to the outcoupler (e.g., via one or more optical waveguides). It is appreciated that in some embodiments, the first signal, the second signal, the third signal, and/or the fourth signal may be orthogonal to each other. A combined signal (representative of the first, second, third, and fourth signal) may be received via an incoupler. In some embodiments, the incoupler is adapted to separate the combined signal into the first signal, the second signal, the third signal, and the fourth signal for differential readout, which can subsequently be utilized to reconstruct the data signal (see, e.g., block 220-235).

Block 220 shows generating a combined signal (e.g., output signal 149) representative of the modulated signal (e.g., the first signal 141-A and the second signal 141-B) out of the first photonic integrated circuit 110 via outcoupler 145. It is appreciated that the outcoupler 145 is structured to preserve the combined signal (e.g., is polarization independent). In some embodiments, the combined signal may be received by or otherwise propagate through optical fiber 157.

Block 225 illustrates receiving a combined signal via incoupler 165 of the second photonic integrated circuit 160. The incoupler 165 is adapted to separate the combined signal into the first signal 141-A and the second signal 141-B. More specifically, incoupler 165 directs the first signal 141-A and the second signal 141-B to respective waveguides 170 (e.g., off-state waveguide 170-A and on-state waveguide 170-B). It is appreciated that in some embodiments, the optical modes of the first signal 141-A and the second signal 141-B may not necessarily be the same as when the first signal 141-A and the second signal 141-B is traversing the first photonic integrated circuit 110.

Block 230 illustrates directing (e.g., via incoupler 165 in combination with waveguides 170) constituent components of the combined signal (e.g., the first signal 141-A and the second signal 141-B) to respective photodetectors (e.g., first photodetector 175-A and second photodetector 175-B) to generate corresponding voltage signals (e.g., 177-A and 177-B) respectively representative of the first signal 141-A and the second signal 141-B. For example, the first signal 141-A may be directed from the incoupler 165 to first photodetector 175-A to generate a first voltage signal 177-A, which is representative the first signal 141-A. The second signal 141-B may be directed from the incoupler 165 to a second photodetector 175-B to generate a second voltage signal 177-B, which is representative of the second signal 141-B.

Block 235 shows differentially reading out the first signal 141-A and the second signal 141-B (e.g., via the first voltage signal 177-A and the second voltage signal 177-B using differential amplifier 180) to determine a differential signal 185 representative of the modulated signal (e.g., the information from the data signal 160 imparted on the optical carrier wave 101). In some embodiments, the differential signal 185 corresponds to a difference between the first voltage signal 177-A and the second voltage signal 177-B.

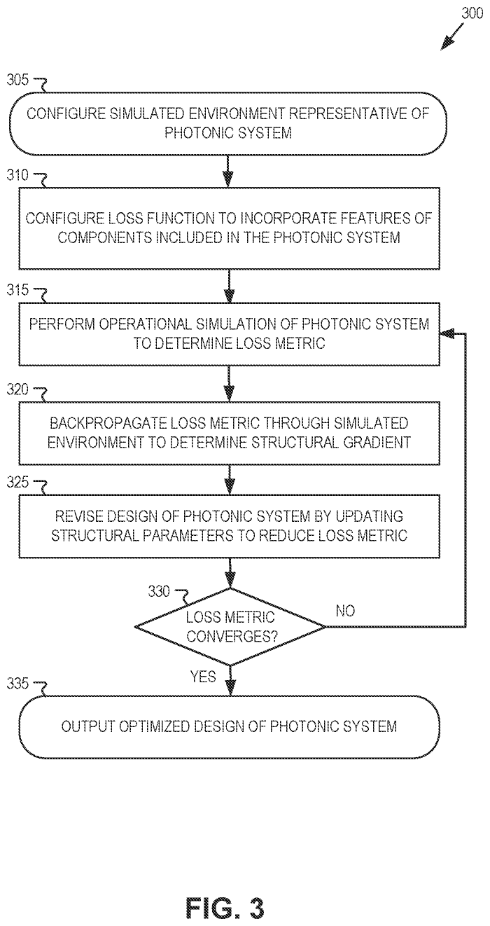

FIG. 3 illustrates a process 300 for inverse design of a photonic system (e.g., photonic system 100 illustrated in FIG. 1A-1F), in accordance with an embodiment of the disclosure. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel.

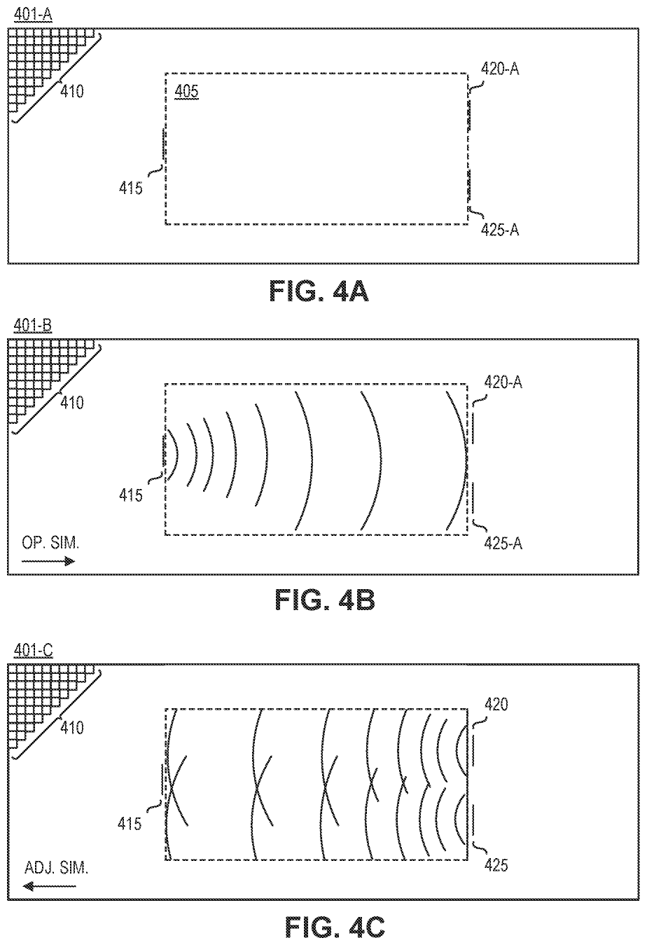

Block 305 shows configuring a simulated environment to be representative of a photonic system (e.g., first photonic integrated circuit 110, second photonic integrated circuit 160, and their constituent photonic components). The simulated environment may be configured as pixels or voxels (see, e.g., FIG. 4A), in which structural parameters (e.g., refractive index), optical carrier wave properties (e.g., power, frequency, phase, polarization, and the like) and targeted performance parameters are set or otherwise configured.

Block 310 shows configuring one or more loss functions to incorporate features of components included in the photonic system. The loss function(s) may incorporate performance parameters of one or more components included in the photonic system such that the constituent components are optimized concurrently, which may include design regions of the modulation region 130, outcoupler 145, and incoupler 165).

Block 315 illustrates performing an operational simulation of the photonic system to determine a loss metric (e.g., based on a loss function(s) configured in block 310). The loss metric may provide information as to how the photonic system or components of the photonic system such as the optical modulator performs relative to the targeted performance metrics (see, e.g., FIG. 4B).

Block 320 shows backpropagating the loss metric (e.g., as an adjoint simulation) through the simulated environment to determine a structural gradient. It is appreciated that the structural gradient may identify how changing the structural parameters of each of the voxels or pixels included in the simulated environment may affect the loss metric or value. In this way, it can be determined which changes of the structural parameters for which voxels or pixels can be used to reduce (i.e., optimize) the loss metric or value. For example, it may not make sense to modify a structural parameter of a voxel that has limited impact on reducing the loss metric.

Block 325 illustrates revising the design of the photonic system by updating the structural parameters to reduce the loss metric or value. This may be achieved, for example, by flipping the structural parameters for voxels with the largest structural gradient to an opposite material (e.g., flipping the material of a given voxel from first material 107 to second material 108 or vice versa). Alternatively, small changes to the structural parameters may be utilized instead of flipping. For example, a given voxel may have a material value of 0.5 which may correspond to between first material 107 and second material 108. As the iterations progress, the material value for the given value may gradually shift towards 0 or 1, indicating that the material should either be first material 107 or second material 108.

Block 330 shows a check to see if the loss metric converges or otherwise saturates based on the design of the photonic system after being revised. If the loss metric does not converge, then block 330 proceeds to block 315 and the iterative process continues. However, if the loss metric does converge or some other parametric indicates and end of the simulation (e.g., time or computational cost budget reached), then block 330 proceeds to block 335 were an output of the optimized design of the photonic system and/or one or more components of the photonic system is provided (e.g., as a schematic).

FIGS. 4A-4C illustrate an initial setup, an operational simulation, and an adjoint simulation of a simulated environment 401, respectively, for optimizing structural parameters of a physical device (e.g., the photonic system 100 or constituent components included in the photonic system 100) with a design model, in accordance with an inverse design embodiment. The simulated environment 401 and corresponding initial setup, operational simulation, adjoint simulation, and structural parameter optimization may be achieved via a physics simulator using Maxwell's equations. As illustrated in FIGS. 4A-4C, the simulated environment is represented in two-dimensions, however it is appreciated that higher dimensionality (e.g., 3-dimensional space) may also be used to describe the simulated environment 401 and the physical device. In some embodiments, the optimization of the structural parameters of the physical device illustrated in FIGS. 4A-4C may be achieved via, inter alia, simulations (e.g., time-forward and backpropagation) that utilize a finite-difference time-domain (FDTD) method to model the field responses (e.g., both electric and magnetic).

FIG. 4A illustrates an example rendering of a simulated environment 401-A describing an electromagnetic or physical device. The simulated environment 401-A represents the simulated environment 401 at an initial time step (e.g., an initial set up) for optimizing structural parameters of the physical device. The physical device described by the simulated environment 401 may correspond to a component of the photonic system 100 (e.g., optical modulator 125) having a designable region 405 (e.g., modulation region 130) in which the structural parameters of the simulated environment may be designed, modified, or otherwise changed. The simulated environment 401 includes an excitation source (e.g., a gaussian pulse, a wave, a waveguide mode response, and the like) at the location of input waveguide or port 415. The electrical and magnetic fields (e.g., field response) within the simulated environment 401 (and the physical device) may change in response to the excitation source. The specific settings of the initial structural parameters, excitation source, performance parameters, and other metrics (i.e., initial description) for a first-principles simulation of a physical device are input before the operational simulation starts.

As illustrated, the simulated environment 401 (and subsequently the physical device) is described by a plurality of voxels 410, which represent individual elements of the two-dimensional (or three-dimensional) space of the simulated environment. Each of the voxels is illustrated as two-dimensional squares, however it is appreciated that the voxels may be represented as cubes or other shapes in three-dimensional space. It is appreciated that the specific shape and dimensionality of the plurality of voxels 410 may be adjusted depending on the simulated environment 401. It is further noted that only a portion of the plurality of voxels 410 are illustrated to avoid obscuring other aspects of the simulated environment 401. Each of the plurality of voxels 410 is associated with one or more structural parameters, a field value to describe a field response, and a source value to describe the excitation source at a specific position within the simulated environment 401. The field response, for example, may correspond to a vector describing the electric and/or magnetic field at a particular time step for each of the plurality of voxels 410. More specifically, the vector may correspond to a Yee lattice that discretizes Maxwell's equations for determining the field response. In some embodiments, the field response is based, at least in part, on the structural parameters and the excitation source.

FIG. 4B illustrates an example operational simulation of the simulated environment 401-B at a particular time step in which the excitation source is active (e.g., generating waves originating at the input waveguide or port 415 that propagate through the simulated environment 401). As mentioned, the physical device is an optical modulator that may be operating at the frequency of interest and having a particular waveguide mode (e.g., transverse electromagnetic mode, transverse electric mode, etc.) and the excitation source is at an input port 415. Operational simulations occur over a plurality of time steps, including the illustrated time step. When performing the operational simulation, changes to the field response (e.g., the field value) for each of the plurality of voxels 410 are updated in response to the excitation source and based, at least in part, on the structural parameters of the physical device at each of the plurality of time steps. Similarly, in some embodiments the source value is updated for each of the plurality of voxels (e.g., in response to the electromagnetic waves from the excitation source propagating through the simulated environment). It is appreciated that the operational simulation is incremental and that the field value (and source value) is updated incrementally at each time step as time moves forward for each of the plurality of time steps. It is further noted that in some embodiments, the update is an iterative process and that the update of each field and source value is based, at least in part, on the previous update of each field and source value.

When performing the operational simulation, performance loss functions may be computed at output ports 420 (e.g., 420-A corresponding to output waveguide 140-A and 420-B corresponding to output waveguide 140B) based, at least in part, on a comparison (e.g., mean squared difference) between the field response and a desired field response at a designated time step (e.g., a final time step of the operational simulation) or across a plurality of time steps (e.g., with a running discrete Fourier transform to use a frequency response of the physical device) at a given port. A performance loss value may be described in terms of a specific performance value (e.g., power). Structural parameters may be optimized for this specific performance value.

FIG. 4C illustrates an example backpropagation of performance loss error backwards within the simulated environment 401-C describing the physical device. In one embodiment, the adjoint performance simulation injects a performance loss error at output ports 420-A and 420-B as a sort of reverse excitation source for stimulating a reverse field response through voxels 410 of simulated environment 401-C. The adjoint performance simulation of the performance loss error determines an influence that changes in the structural parameters of voxels 410 have on the performance loss value.

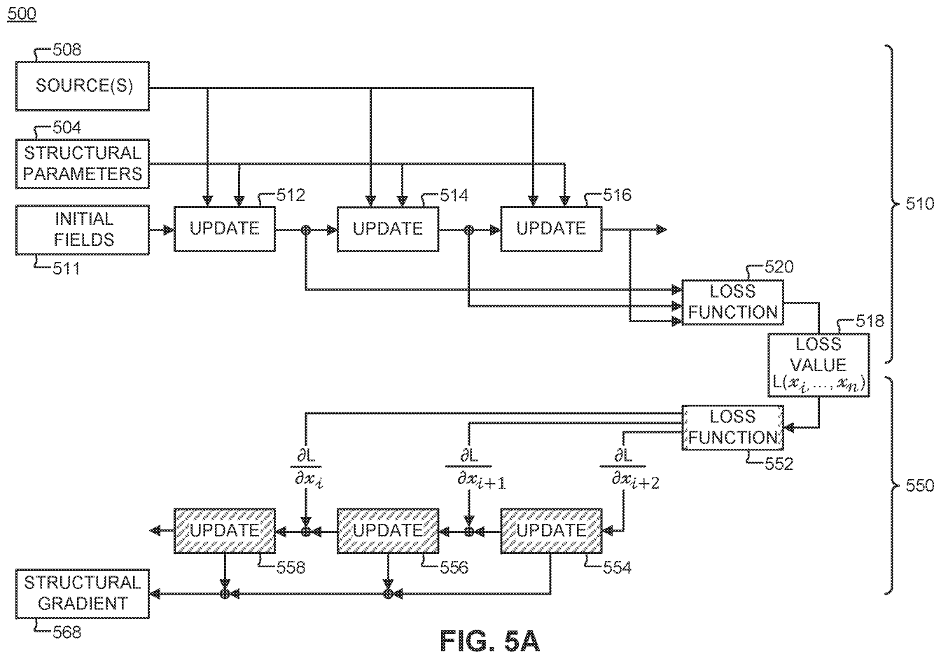

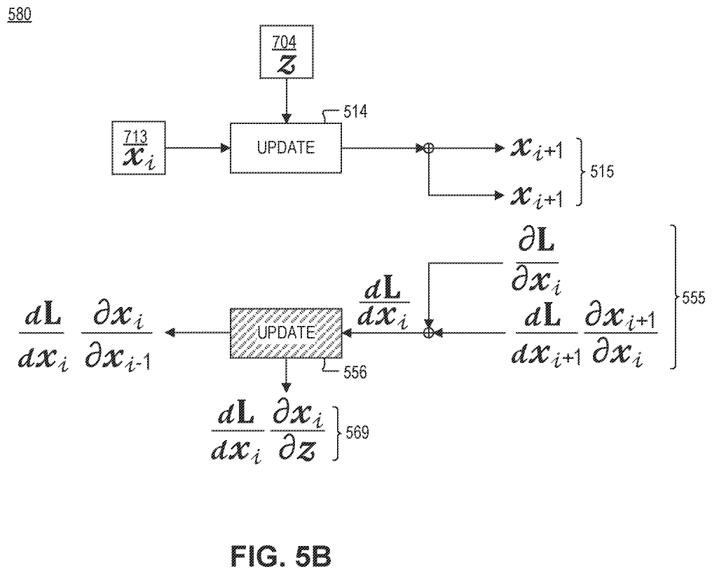

FIG. 5A is a flow chart 500 illustrating example time steps for a time-forward simulation 510 and backpropagation 550 within a simulated environment, in accordance with an embodiment of the present disclosure. Flow chart 500 is one possible implementation that a design model may use to perform a forward operational simulation 510 and backpropagation 550 of a simulated environment. In the illustrated embodiment, the forward operational simulation utilizes a FDTD method to model the field response (both electric and magnetic) at a plurality of time steps in response to an excitation source. More specifically, the time-dependent Maxwell's equations (in partial differential form) are discretized to solve for field vector components (e.g., the field response of each of the plurality of voxels 410 of the simulated environment 401 in FIGS. 4A-4C) over a plurality of time steps.

As illustrated in FIG. 5A, the flow chart 500 includes update operations for a portion of operational simulation 510 and adjoint simulation 550. Operational simulation 510 occurs over a plurality of time-steps (e.g., from an initial time step to a final time step over a pre-determined or conditional number of time steps having a specified time step size) and models changes (e.g., from the initial field values 511) in electric and magnetic fields of a plurality of voxels describing the simulated environment and/or physical device that collectively correspond to the field response. More specifically, update operations (e.g., 512, 514, and 516) are iterative and based on the field response, structural parameters 504, and one or more physical stimuli sources 508. Each update operation is succeeded by another update operation, which are representative of successive steps forward in time within the plurality of time steps. For example, update operation 514 updates the field values based on the field response determined from the previous update operation 512, sources 508, and the structural parameters 504. Similarly, update operation 516 updates the field values based on the field response determined from update operation 514. In other words, at each time step of the operational simulation the field values (and thus field response) are updated based on the previous field response and structural parameters of the physical device. Once the final time step of the operational simulation 510 is performed, the loss value 518 may be determined (e.g., based on a pre-determined loss function 520). The loss gradients determined from block 552 may be treated as adjoint or virtual sources (e.g., physical stimuli or excitation source originating at an output region) which are backpropagated in reverse (from the final time step incrementally through the plurality of time steps until reaching the initial time step) to determine structural gradient 568.

In the illustrated embodiment, the FDTD solve (e.g., time-forward simulation 510) and backpropagation 550 problem are described pictorially, from a high-level, using only “update” and “loss” operations as well as their corresponding gradient operations. The simulation is set up initially in which the structure parameters, the excitation source, and the initial field states of the simulated environment (and electromagnetic device) are provided. As discussed previously, the field states are updated in response to the excitation source based on the structural parameters. More specifically, the update operation is given by ϕ, where xᵢ₊₁=ϕ(xᵢ, [symbol] ᵢ, z) for i=1, . . . [symbol] . Here, [symbol] corresponds to the total number of time steps (e.g., the plurality of time steps) for the time-forward simulation, xᵢ corresponds to the field response (the field value associated with the electric and magnetic fields of each of the plurality of voxels) of the simulated environment at time step i, [symbol] ᵢ corresponds to the excitation source(s) (the source value associated with the electric and magnetic fields for each of the plurality of voxels) of the simulated environment at time step i, and z corresponds to the structural parameters describing the topology and/or material properties of the electromagnetic device.

It is noted that using the FDTD method, the update operation can specifically be stated as:

$$ϕ ( {𝓍}_{𝒾} , {𝒾}_{} , 𝓏 ) = A ( 𝓏 ) {𝓍}_{𝒾} + B ( 𝓏 ) {𝒾}_{} . \qquad ( 1 )$$

That is to say the FDTD update is linear with respect to the field and source terms. Concretely, A(z)∈ [symbol] ^{N×N} and B (z)∈ [symbol] ^{N×N} are linear operators which depend on the structure parameters, z, and act on the fields, xᵢ, and the sources, [symbol] ᵢ, respectively. Here, it is assumed that xᵢ, [symbol] ᵢ∈ [symbol] ^{N} where N is the number of FDTD field components in the time-forward simulation. Additionally, the loss operation is given by L=(xᵢ, . . . , xₙ), which takes as input the computed fields and produces a single, real-valued scalar (e.g., the loss value) that can be reduced and/or minimized.

In terms of revising or otherwise optimizing the structural parameters of the electromagnetic device, the relevant quantity to produce is

$$\frac{dL}{d 𝓏} ,$$

which is used to describe the change in the loss value with respect to a change in the structural parameters of the electromagnetic device and is denoted as the “structural gradient” illustrated in FIG. 5A.

FIG. 5B is a chart 580 illustrating the relationship between the update operation for the operational simulation and the adjoint simulation (e.g., backpropagation), in accordance with an embodiment of the present disclosure. More specifically, FIG. 5B summarizes the operational and adjoint simulation relationships that are involved in computing the structural gradient,

$$\frac{dL}{d 𝓏} ,$$

which include

$$\frac{\partial L}{\partial {𝓍}_{𝒾}} , \frac{\partial {𝓍}_{𝒾 + 1}}{\partial {𝓍}_{𝒾}} , \frac{dL}{d {𝓍}_{𝒾}} , and \frac{\partial {𝓍}_{𝒾}}{\partial 𝓏} .$$

The update operation 514 of the operational simulation updates the field values 513, xᵢ, of the plurality of voxels at the ith time step to the next time step (i.e., i+1 time step), which correspond to the field values 515, xᵢ₊₁. The gradients 555 are utilized to determine

$$\frac{dL}{d {𝓍}_{𝒾}}$$

for the backpropagation (e.g., update operation 556 backwards in time), which combined with the gradients 569 are used, at least in part, to calculate the structural gradient,

$$\frac{dL}{d 𝓏} . \frac{\partial L}{\partial {𝓍}_{𝒾}}$$

is the contribution of each field to the loss value, L. It is noted that this is the partial derivative, and therefore does not take into account the causal relationship of xᵢ→xᵢ₊₁. Thus,

$$\frac{\partial {𝓍}_{𝒾 + 1}}{\partial {𝓍}_{𝒾}}$$

is utilized which encompasses the xᵢ→xᵢ₊₁ relationship. The loss gradient,

$$\frac{dL}{d {𝓍}_{𝒾}}$$

may also be used to compute the structural gradient,

$$\frac{dL}{d 𝓏} ,$$

and corresponds to the total derivative of the field with respect to loss value, L. The loss gradient,

$$\frac{dL}{d {𝓍}_{𝒾}} ,$$

at a particular time step, i, is equal to the summation of

$$\frac{\partial L}{\partial {𝓍}_{𝒾}} + \frac{dL}{d {𝓍}_{𝒾 + 1}} \frac{\partial {𝓍}_{𝒾 + 1}}{\partial {𝓍}_{𝒾}} .$$

Finally,

$$\frac{\partial {𝓍}_{𝒾}}{\partial 𝓏} ,$$

which corresponds to the field gradient, is used which is the contribution to

$$\frac{dL}{d 𝓏}$$

from each time/update step.

$$\frac{dL}{d 𝓏}$$

is given by:

$$\frac{dL}{d 𝓏} = {\sum }_{𝒾} \frac{dL}{d {𝓍}_{𝒾}} \frac{\partial {𝓍}_{𝒾}}{\partial 𝓏} . \qquad ( 2 )$$

For completeness, the full form of the first time in the sum,

$$\frac{dL}{d 𝓏} ,$$

is expressed as:

$$\frac{dL}{d {𝓍}_{𝒾}} = \frac{\partial L}{\partial {𝓍}_{𝒾}} + \frac{dL}{d {𝓍}_{𝒾 + 1}} \frac{\partial {𝓍}_{𝒾 + 1}}{\partial {𝓍}_{𝒾}} . \qquad ( 3 )$$

Based on the definition of ϕ as described by equation (1), it is noted that

$$\frac{\partial {𝓍}_{𝒾 + 1}}{\partial {𝓍}_{𝒾}} = A ( 𝓏 ) ,$$

which can be substituted in equation (3) to arrive at an adjoint update for backpropagation (e.g., the update operations such as update operation 756), which can be expressed as:

$$\frac{dL}{d {𝓍}_{𝒾}} = \frac{\partial L}{\partial {𝓍}_{𝒾}} + \frac{dL}{d {𝓍}_{𝒾 + 1}} A ( 𝓏 ) , \qquad ( 4 )$$

$$or$$

$${∇}_{{𝓍}_{𝒾}} L = {A ( 𝓏 )}^{T} {∇}_{{𝓍}_{𝒾 + 1}} L + \frac{\partial {L}^{T}}{\partial {𝓍}_{𝒾}} . \qquad ( 5 )$$

The adjoint update is the backpropagation of the loss gradients from later to earlier time steps and may be referred to as a backwards solve for

$$\frac{dL}{d {𝓍}_{𝒾}} .$$

The second term in the sum of the structural gradient,

$$\frac{dL}{d 𝓏} ,$$

is denoted as:

$$\frac{\partial {𝓍}_{𝒾}}{\partial 𝓏} = \frac{d ϕ ( {𝓍}_{𝒾 - 1} , {𝒾 - 1}_{} , 𝓏 )}{d 𝓏} = \frac{dA ( 𝓏 )}{d 𝓏} {𝓍}_{𝒾 - 1} + \frac{dB ( 𝓏 )}{d 𝓏} {𝒾 - 1}_{} , \qquad ( 6 )$$

for the particular form of ϕ described by equation (1).

Some processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A photonic integrated circuit, comprising:
an optical modulator, including:
a modulation region including an inhomogeneous arrangement of two or more different materials having different refractive indexes to structure the modulation region to manipulate one or more optical properties of an optical carrier wave in response to a modulation bias; and
a modulation actuator disposed proximate to the modulation region and adapted to apply the modulation bias to the modulation region to generate a first signal and a second signal collectively representative of a modulated signal by adjusting the one or more optical properties of the optical carrier wave within the modulation region;
one or more waveguides optically coupled to the modulation region to receive the first signal and the second signal; and
an outcoupler optically coupled to the one or more waveguides to receive the first signal and the second signal, wherein the outcoupler is adapted to preserve the first signal and the second signal as a combined signal directed out of the photonic integrated circuit.

2. The photonic integrated circuit of claim 1, wherein the one or more waveguides includes a first waveguide to receive the first signal and a second waveguide to receive the second signal, wherein the first waveguide is physically separated from the second waveguide.

3. The photonic integrated circuit of claim 2, wherein the modulated signal includes a first state represented by the first signal and a second state represented by the second signal, and wherein a first portion of the optical carrier wave is selectively steered by the inhomogeneous arrangement of the modulation region to the first waveguide in response to the modulation bias when the modulated signal is modulated to the first state.

4. The photonic integrated circuit of claim 3, wherein a second portion of the optical carrier wave is selectively steered by the inhomogeneous arrangement of the modulation region to the second waveguide in response to the modulation bias when the modulated signal is modulated to the second state.

5. The photonic integrated circuit of claim 2, wherein the first waveguide and the second waveguide physically abut the modulation region at different physical locations of the modulation region, and wherein the first waveguide and the second waveguide physically abut the outcoupler at different physical locations of the outcoupler.

6. The photonic integrated circuit of claim 2, wherein the first signal and the second signal respectively transverse the first waveguide and the second waveguide with a common mode to simultaneously represent different states of the modulated signal.

7. The photonic integrated circuit of claim 6, wherein the outcoupler is structured to receive the first signal and the second signal with the common mode at separate physical locations and generate an output signal having different modes to preserve the first signal and the second signal of the modulated signal.

8. The photonic integrated circuit of claim 1, wherein the inhomogeneous arrangement of the modulation region is structured to adjust a mode of the optical carrier wave in response to the modulation bias such that the first signal traverses the first waveguide with a first mode and the second signal traverses the first waveguide with a second mode different from the first mode.

9. The photonic integrated circuit of claim 8, wherein the first mode is orthogonal to the second mode.

10. The photonic integrated circuit of claim 1, wherein at least one of the modulation region of the optical modulator or a dispersive region of the outcoupler include homogeneous compositions of the first material and the second material inhomogeneously interspersed within the modulation region or the dispersive region.

11. A photonic system, comprising:
an optical modulator, including:
a modulation region including an inhomogeneous arrangement of two or more different materials having different refractive indexes to structure the modulation region to manipulate one or more optical properties of an optical carrier wave in response to a modulation bias; and
a modulation actuator disposed proximate to the modulation region and adapted to apply the modulation bias to the modulation region to generate a first signal and a second signal collectively representative of a modulated signal by adjusting the one or more optical properties of the optical carrier wave within the modulation region;
an outcoupler optically coupled to the modulation region to receive the first signal and the second signal, wherein the outcoupler is adapted to preserve the first signal and the second signal as a combined signal to be received by an optical fiber; and
an incoupler adapted to be optically coupled to the optical fiber to receive the combined signal and separate the combined signal into the first signal and the second signal.

12. The photonic system of claim 11, wherein at least one of the modulation region of the optical modulator, a dispersive region of the outcoupler, or a dispersive region of the incoupler include homogeneous compositions of the first material and the second material inhomogeneously interspersed within the modulation region, the dispersive region of the outcoupler, or the dispersive region of the incoupler.

13. The photonic system of claim 11, further comprising at least two waveguides optically coupled to the incoupler, including an off-state waveguide to receive the first signal and an on-state waveguide to receive the second signal.

14. The photonic system of claim 13, further comprising a first photodetector optically coupled to the off-state waveguide to receive the first signal and a second photodetector optically coupled to the on-state waveguide to receive the second signal, wherein the first photodetector and the second photodetector are respectively adapted to generate a first voltage signal representative of the first signal and a second voltage signal representative of the second signal.

15. The photonic system of claim 14, further comprising a differential amplifier to receive the first voltage signal and the second voltage signal to generate a differential signal indicative of a difference between the first voltage signal and the second voltage signal, wherein the differential signal is representative of the modulated signal.

16. The photonic system of claim 13, wherein the off-state waveguide and the on-state waveguide abut the incoupler at different physical locations, and wherein the incoupler is configured to direct the first signal to the off-state waveguide and to direct the second signal to the on-state waveguide.

17. The photonic system of claim 11, further comprising one or more waveguides abutting the modulation region and the outcoupler to direct the first signal and the second signal from the modulation region to the outcoupler.

18. A method of operation of a photonic system, the method comprising:
receiving an optical carrier wave at a modulation region of an optical modulator, wherein the modulation region includes an inhomogeneous arrangement of two or more different materials having different refractive indexes to structure the modulation region to manipulate one or more optical properties of the optical carrier wave in response to a modulation bias;
modulating the modulation bias applied to the modulation region to generate a first signal and a second signal collectively representative of a modulated signal, wherein the modulation bias adjusts at least one of the different refractive indexes of the inhomogeneous arrangement to provide variable control of the one or more optical properties of the optical carrier wave; and
directing the first signal and the second signal out of a photonic integrated circuit including the optical modulator as a combined signal preserved by an outcoupler optically coupled to the modulation region.

19. The method of claim 18, further comprising:
imparting a data signal upon the optical carrier wave to generate the modulated signal modulating the modulation bias, wherein the modulated signal includes a first state represented by the first signal and a second state represented by the second signal;
directing a first portion of the optical carrier wave to the outcoupler via a first waveguide when the modulated signal is modulated to a first state based upon a first logic state of the data signal; and
directing a second portion of the optical carrier wave to the outcoupler via a second waveguide when the modulated signal is modulated to a second state based upon a second logic state of the data signal.

20. The method of claim 19, wherein the first signal and the second signal share a common mode when received by the outcoupler at different physical locations of the outcoupler.

21. The method of claim 18, further comprising:
imparting a data signal upon the optical carrier wave to generate the modulated signal modulating the modulation bias, wherein the modulated signal includes a first state represented by the first signal and a second state represented by the second signal;
directing a first portion of the optical carrier wave to the outcoupler via a first waveguide with a first mode when the modulated signal is modulated to a first state based upon a first logic state of the data signal; and
directing a second portion of the optical carrier wave to the outcoupler via the first waveguide with a second mode, orthogonal to the first mode, when the modulated signal is modulated to a second state based upon a second logic state of the data signal.

22. The method of claim 18, further comprising:
receiving a combined signal via an incoupler adapted to separate the combined signal into the first signal and the second signal; and
differentially reading out the first signal and the second signal to determine a differential signal representative of the modulated signal.

23. The method of claim 22, further comprising:
directing the first signal from the incoupler to a first photodetector to generate a first voltage signal representative the first signal; and
directing the second signal from the incoupler to a second photodetector to generate a second voltage signal representative of the second signal, and wherein the differential signal corresponds to a difference between the first voltage signal and the second voltage signal.

24. The method of claim 18, further comprising:
imparting a data signal upon the optical carrier wave to generate the modulated signal modulating the modulation bias, wherein the modulating the modulation bias further generates a third signal and a fourth signal, wherein the modulated signal includes at least a first state represented by the first signal, a second state represented by the second signal, a third state represented by the third signal, and a fourth state represented by the fourth signal;
directing a first portion, a second portion, a third portion, and a fourth portion of the optical carrier wave to the outcoupler when the modulated signal is modulated to a first state, the second state, the third state, or the fourth state, respectively based on corresponding states of the data signal; and
receiving a combined signal via an incoupler adapted to separate the combined signal into the first signal, the second signal, the third signal, and the fourth signal, respectively; and
differentially reading out the first signal, the second signal, the third signal, and the fourth signal to determine one or more differential signals collectively representative of the modulated signal.
